(19) United States
(12) Patent Application Publication
(10) Pub. No.: US 2010/0269302 A1
(43) Pub. Date: Oct. 28, 2010

(54) DOOR HINGE STOP MECHANISM

(76) Inventor: Govindarajan JAGANNATHAN, Oakton, VA (US)

Correspondence Address: PILLSBURY WINTHROP SHAW PITTMAN LLP, P.O. BOX 10500, MCLEAN, VA, 22102, US

(21) Appl. No.: 12/769,465

(22) Filed: Apr. 28, 2010

Related U.S. Application Data
(60) Provisional application No. 61/173,508, filed on Apr. 28, 2009.

(51) Int. Cl. E05D 11/06

(52) U.S. Cl. 16/374

(57) ABSTRACT

In general, the present invention concerns preventing the movement of a door beyond a certain preset angle using a mechanism that is integrally formed in a door hinge. In embodiments, the invention includes a device comprises a standard hinge with the addition of a pair of stopping knuckles integrally formed on both sides of the hinge in an opposing position. The stopping knuckles do not wrap around the hinge pin like normal knuckles, instead they are formed to protrude out at a predetermined angle for a small length. This device is mounted like any normal hinge and when opened to the predetermined angle the stopping knuckles will abut against each other and stop the door from opening any further, thereby preventing any damage to the wall that might be struck by a portion of the door. This is important in that many door hinges will be allowed to rotate freely and frequently a part of the door will strike the structure that is located behind the door. According to some aspects, the device is as easy to install as any conventional door hinge and allows the door to rotate freely, but will prevent the door from moving beyond a certain point and therefore prevent the door from damaging the drywall or mirror that may be placed behind the door.

### CROSS-REFERENCE TO RELATED APPLICATIONS

The present application claims priority to U.S. Prov. Appln. No. 61/173,508 filed Apr. 28, 2009, the contents of which are incorporated herein by reference in their entirety.

### FIELD OF THE INVENTION

The present invention relates generally to door hinges, and specifically to a mechanism for preventing the movement of a door hinge beyond a certain preset or predetermined angle.

### BACKGROUND OF THE INVENTION

The prior art is replete with references to hinges and hinge mechanisms. Hinges are used on a variety of types of doors, among other things. In one common example application, one side of a hinge is attached to the structure of the building or house (e.g. door frame) and the other supports the door. As the door is opened or closed, one section of the hinge will move and the other will be stationary on the door structure.

The doors may be interior doors such as a door leading to an interior room of a house or the door may be an exterior door such as a door that leads outside. In this fashion the door is allowed to rotate so as to provide access into or out of the room or building. Many other applications of hinges are known to those skilled in the art, such as cabinet doors, hatches, some types of windows, etc.

If the movement of the door is allowed to rotate completely the door handle may strike a piece of dry wall, for instance, that has been installed as part of the room wall that forms the structure. Additionally, mirrors are often placed behind door hinges and the door handle may damage a mirror. These occurrences will make it necessary to repair sections of the wall or replace a damaged mirror.

The prevention of this type of damage is particularly important when a door with a significant amount of weight is used, such as a metal door.

Many door stopping mechanisms are known, and they typically comprise external door stoppers attached to walls or additional elements attached to hinges.

Some past solutions have considered hinges that include door stopping mechanisms. For example, U.S. Patent Pub. No. 2009/0211055 teaches a door stop that limits the movement of the hinge by stopping one side of the hinge against the hinge pin. The device will limit the movement of the door using the hinge pin and the sleeve. As another example, U.S. Pat. No. 5,881,431 teaches a door stop that limits the movement of a hinged panel that can be mounted directly to a door stop. The device will limit the movement of the door and is mounted on the hinge of a door. As further examples, U.S. Pat. No. 6,851,159, U.S. Pat. No. 6,739,020 and U.S. Pat. No. 6,149,212 disclose door hinges for automobiles. These devices include a built in stop and an adjustable door stop mechanism that allow a door to be opened to a desired angle setting.

However, there remains a need in the art for a mechanism to stop a door at a predetermined angle in which no modifications need be made to the door and the device can be easily installed without using special tools or altering the hinge.

### SUMMARY OF THE INVENTION

In general, the present invention concerns preventing the movement of a door beyond a certain preset angle using a mechanism that is integrally formed in a door hinge. In embodiments, the invention includes a device comprises a standard hinge with the addition of a pair of stopping knuckles integrally formed on both sides of the hinge in an opposing position. The stopping knuckles do not wrap around the hinge pin like normal knuckles, instead they are formed to protrude out at a predetermined angle for a small length. This device is mounted like any normal hinge and when opened to the predetermined angle the stopping knuckles will abut against each other and stop the door from opening any further, thereby preventing any damage to the wall that might be struck by a portion of the door. This is important in that many door hinges will be allowed to rotate freely and frequently a part of the door will strike the structure that is located behind the door. According to some aspects, the device is as easy to install as any conventional door hinge and allows the door to rotate freely, but will prevent the door from moving beyond a certain point and therefore prevent the door from damaging the drywall or mirror that may be placed behind the door.

In accordance with these and other aspects, a hinge mechanism according to the invention includes a hinge having a first side and a second side separate from the first side, the first side and second side having complementary knuckles, the knuckles defining openings therethrough, a hinge pin adapted to be inserted through the openings and thereby rotatably connect the second side to the first side, and a pair of stopping knuckles integrally formed on both sides of the hinge that are operative to prevent relative rotation of the first side and second side beyond a predetermined angle.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a view of a door hinge device according to embodiments of the invention;

FIG. 2 is an opposite view of the device shown in FIG. 1;

FIGS. 3A and 3B illustrate an alternative embodiment of a door hinge device according to aspects of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

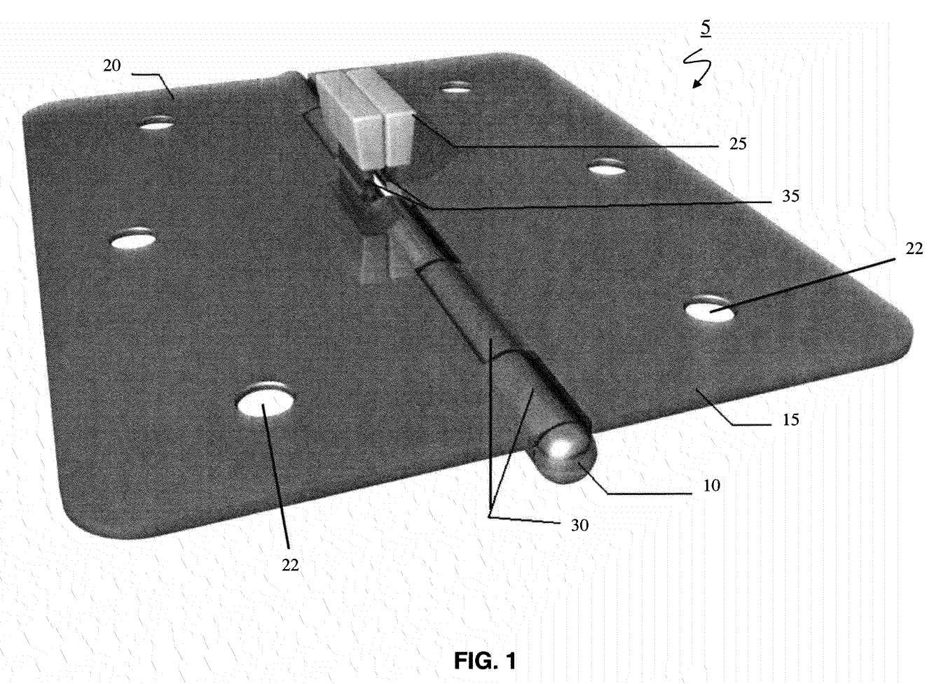

FIG. 1 illustrates an example embodiment according to aspects of the invention. In general, this illustrates device 5, comprised of a conventional hinge with a pair of integrally formed stopping knuckles on both sides, which prevents the movement of a door hinge beyond a certain preset or predetermined angle.

As with conventional door hinges, the hinge of device/mechanism 5 includes two sides, the first side 15, which can be attached to the door structure such as the door frame in the house via screw holes 22, and the second side 20 which can be attached to a door via screw holes 22 and is not mounted to the frame of the building. A hinge pin 10 rotatably connects the first side to the second side through a set of openings in the first and second side formed through a plurality of complementary knuckles 30. As is known, the hinge pin 10 inserted through the openings in the knuckles allows the second side 20 to remain connected and rotate in relation to the first side 15. These types of hinge structures and their installation on doors and structures are well known in the art, and so further explanation thereof is not necessary for an understanding of the present invention.

In this embodiment, with the hinge installed on a door in a conventional manner, for example, the second side of the hinge will be allowed to rotate approximately one hundred eighty degrees, without the stopping mechanism of the invention installed. Unfortunately, the door handle, which protrudes from the door, will strike the wall of the structure before the door reaches one hundred eighty degrees. This may cause damage to the wall behind the door with the resultant repair costs.

According to the invention, therefore, a pair of stopping knuckles 35 in opposing positions are designed and incorporated with the hinge such that the door opens to any desired angle within a predetermined range that does not cause the door or its part to hit a wall or other structure behind the door. For example, as shown in FIG. 1, stopping knuckles 35 comprise protrusions formed on both sides 15 and 20 of the hinge in place of a conventional knuckle 30.

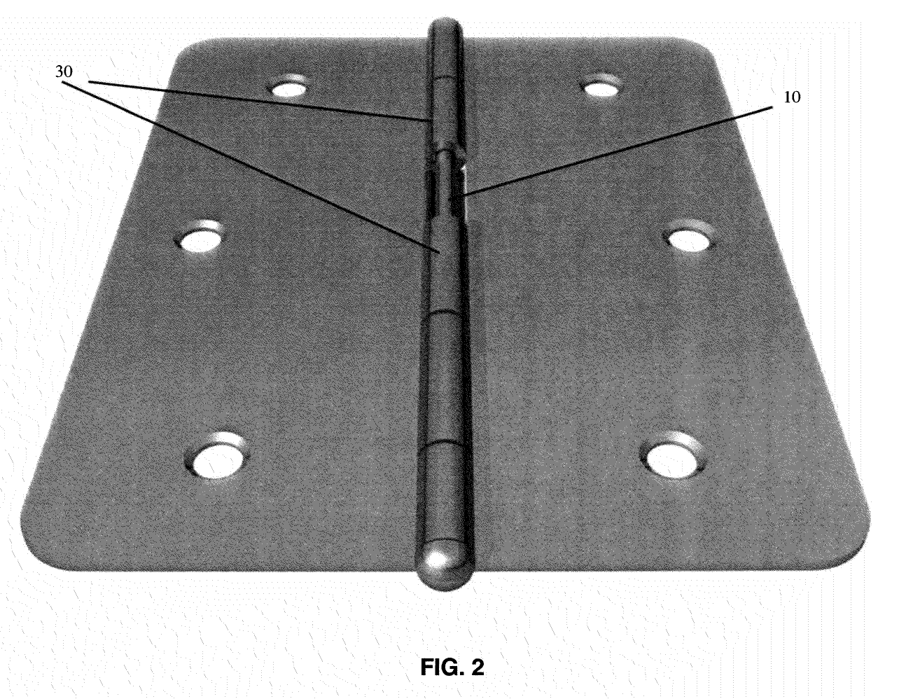

FIG. 2 shows an opposite side of device 5 (with respect to the view in FIG. 1), and further shows how stopping knuckles 35 are formed in place of one of the conventional knuckles 30, where each knuckle 30 occupies about the same space with respect to a length of pin 10. It should be noted that in this example, the stopping knuckles 35 completely occupy the space that would be occupied by a conventional knuckle, and that there is no corresponding material surrounding pin 10 for forming an opening as in conventional knuckles. However, this is not necessary and other embodiments may allow for partial substitution of the space occupied by a conventional knuckle and/or material surrounding pin 10, and/or variations in amount of space occupied by knuckles 30.

In example embodiments, the protrusions are formed using the same material (e.g. metal such as stainless steel) and roughly the same thickness as the sides 15 and 20 of the hinges and extend roughly ninety degrees from the surface of the sides 15 and 20. However, other protruding angles may be used depending on application, and the extension length may vary depending on application, as will become apparent to those skilled in the art. In any event, depending on the protruding angle, when the relative rotation of the sides 15 and 20 reaches the point where the stopping knuckles 35 meet, the door will be caused to stop due to the rigidity of the hinge and protrusion material, thereby eliminating the need for an external stopper to be installed on the wall or surface behind the opened door.

As shown in the embodiment of FIG. 1, the stopping knuckles 35 can further include plastic or rubber sleeves 25 covering them at the point of impact so as to absorb the impact smoothly when the door is opened to reduce noise and vibration. Those skilled in the art will recognize many suitable materials for use as sleeves 25. Moreover, the sleeves 25 may be made of different thicknesses to enable finer adjustment of the door opening angle at the time of installation. A range of sleeve thicknesses can be used to make the angle of opening smaller than the knuckle opening angle in case there are protrusions or other extensions on the surface behind the wall.

Still further, the stopping knuckles sleeves 25 may be made with Velcro on the butting sides so that the mechanism may be also used to act as a holding mechanism keep the door opened and not close because of wind and such unintentional reasons. Moreover, the stopping knuckles sleeves 25 may be made with magnetized material on the butting sides so that the mechanism may be also used to act as a holding mechanism keep the door opened and not close because of wind and such unintentional reasons.

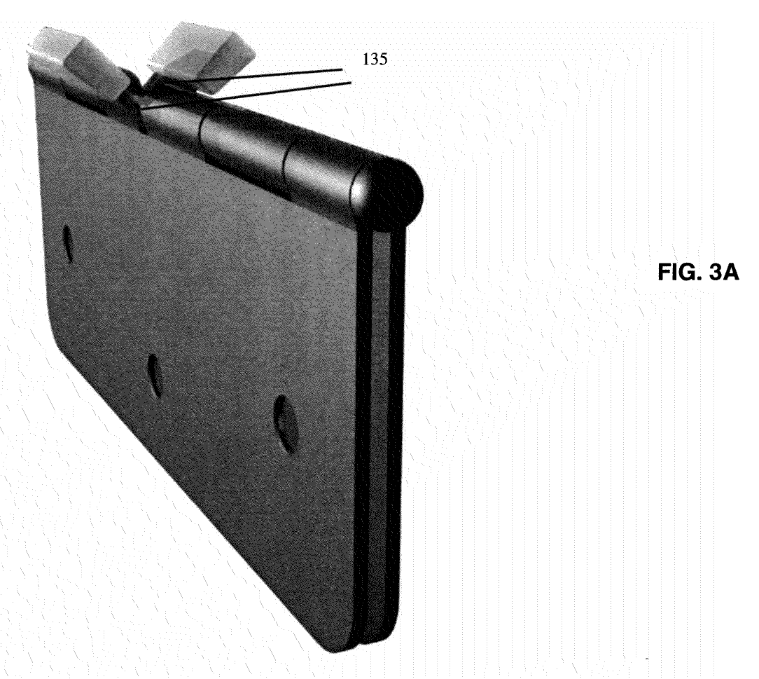

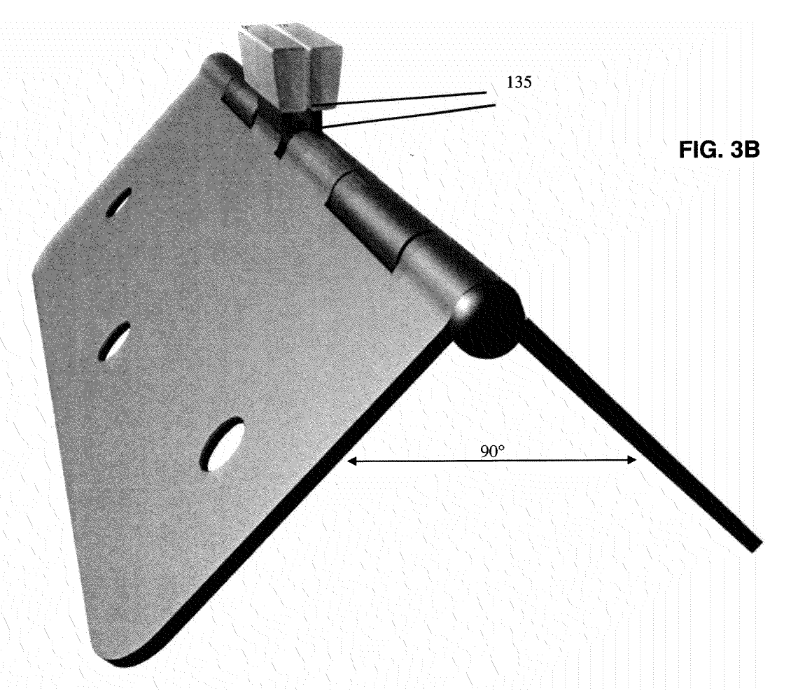

FIGS. 3A and 3B illustrate another embodiment in which stopping knuckles 135 are formed of protrusions that extend approximately 45 degrees (or 135 degrees, depending on perspective) from both sides of the hinge. FIG. 3A also more fully shows the stopping surfaces on knuckles 135 when the door is closed or not fully opened. As further shown in FIG. 3B, this alternative protrusion angle of 45 degrees of knuckles 135 will cause the door to stop opening at approximately 90 degrees (or less, depending on thickness of sleeves 25).

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A hinge mechanism, comprising:
a hinge having a first side and a second side separate from the first side, the first side and second side having complementary knuckles, the knuckles defining openings therethrough;
a hinge pin adapted to be inserted through the openings and thereby rotatably connect the second side to the first side; and
a pair of stopping knuckles integrally formed on both sides of the hinge that are operative to prevent relative rotation of the first side and second side beyond a predetermined angle.

2. A hinge mechanism according to claim 1, wherein the stopping knuckles comprise stopping surfaces that abut against each other at the predetermined angle.

3. A hinge mechanism according to claim 1, wherein the stopping knuckles protrude from the first and second sides away from and so as to not wrap around the hinge pin.

4. A hinge mechanism according to claim 1, wherein the stopping knuckles fully occupy substantially the same space with respect to a length of the hinge pin as each of the plurality of knuckles.

5. A hinge mechanism according to claim 1, wherein the stopping knuckles protrude outwards at protruding angles to thereby define the predetermined angle.

6. A hinge mechanism according to claim 1, further comprising sleeves that cover the stopping knuckles.

7. A hinge mechanism according to claim 1, wherein the sleeves comprise plastic or rubber material that absorbs impact and reduces noise and vibration.

8. A hinge mechanism according to claim 6, further comprising Velcro attached to the stopping surfaces.

9. A hinge mechanism according to claim 6, wherein the stopping surfaces are magentised.
